(19) United States
(12) Patent Application Publication
(10) Pub. No.: US 2006/0210427 A1
(43) Pub. Date: Sep. 21, 2006

(54) Integrated chemical sensing system

(76) Inventor: Jeremy A. Theil, Mountain View, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 11/083,464

(22) Filed: Mar. 18, 2005

(51) Int. Cl. G01N 31/22

(52) U.S. Cl. 422/57; 422/83

(57) ABSTRACT

A chemical sensing system. The chemical sensing system includes a first structure having a first surface, at least one chemical sensor having a detection surface, at least one spacer attached to the first surface, a second structure having a second surface, at least one inlet port, and at least one outlet port. The first structure includes a first semiconductor substrate. The at least one chemical sensor is located on the first surface. The second structure is located over the first structure; the at least one spacer is further attached opposite the first surface to the second surface; and a volume is created thereby between the first surface, the second surface, and the at least one spacer. The at least one inlet and at least one outlet ports have capability of providing entrance for a fluid into the volume and subsequent physical contact of the fluid with the detection surface.

### BACKGROUND

In various situations, as for example in manufacturing processes which employ chemicals in the gaseous and/or liquid state, and for various purposes, as for example the control of such processes, the sounding of alarms, etc., the identification of the chemical constituents comprising a fluid (either a liquid or a gas) is important.

Members of an important class of such chemical sensing and identification systems are referred to as electronic noses. Such systems often include mechanically delicate transducers. The inclusion of a fixed, open volume surrounding the chemical transducer with appropriately designed openings for limiting the free flow of the fluid over the transducer can be used to increase the chemical signal-to-noise ratio of the detection system. This open volume is referred to as headspace. The optimum volume of the headspace depends upon the solubility of the compound by the transducer. Typically, it has proven to be expensive to fabricate components with the designed headspace which often involves molding these components. Creating this headspace in an assembly to the repeatable precision needed has resulted in such chemical sensing systems being typically so expensive that the cost to performance ratio has effectively prohibited their wide use.

Electronic noses typically use an array of transducers that react to a wide range of compounds with their responses differing from each other for any given compound. The transducers are first exposed to a known compound. The responses obtained from all of the transducers are then stored for future use in identifying this compound. The transducers are subsequently exposed to each chemical compound that the chemical sensor system might be employed to identify, and the data sets obtained for those chemical compounds are again stored for future use.

After the chemical sensor system is exposed to an unknown chemical, the data from the exposed, array of transducers is typically analyzed using a pattern recognition algorithm in an attempt to match the measurements of the transducers exposed to the unknown compound to the results obtained from the known chemical compounds in order to identify the constituents of the unknown fluid.

### SUMMARY

In representative embodiments, a chemical sensing system includes a first structure having a first surface, at least one chemical sensor having a detection surface, at least one spacer attached to the first surface, a second structure having a second surface, at least one inlet port, and at least one outlet port. The first structure comprises a first semiconductor substrate. The at least one chemical sensor is located on the first surface. The second structure is located over the first structure; the at least one spacer is further attached opposite the first surface to the second surface; and a volume is created thereby between the first surface, the second surface, and the at least one spacer. The at least one inlet and at least one outlet ports have capability of providing entrance for a fluid into the volume and subsequent physical contact of the fluid with the detection surface.

In another representative embodiment, a method comprises placing at least one chemical sensor having a detection surface on a first structure, attaching at least one spacer to the first surface, locating a second structure having a second surface, over the first structure, and attaching the second surface to the at least one spacer opposite the first surface. The first structure comprises a first surface and a first semiconductor substrate. The at least one chemical sensor is located on the first surface. A volume is created between the first surface, the second surface, and the at least one spacer, and the at least one inlet and at least one outlet ports have capability of providing entrance for a fluid into the volume and subsequent physical contact of the fluid with the detection surface.

Other aspects and advantages of the representative embodiments presented herein will become apparent from the following detailed description, taken in conjunction with the accompanying drawings.

### BRIEF DESCRIPTION OF THE DRAWINGS

The accompanying drawings provide visual representations which will be used to more fully describe various representative embodiments and can be used by those skilled in the art to better understand them and their inherent advantages. In these drawings, like reference numerals identify corresponding elements.

FIG. 1 is a drawing of a side view of an integrated chemical sensing system as described in various representative embodiments.

FIG. 2 is a drawing of a top view of the integrated chemical sensing system of FIG. 1.

FIG. 3 is a flow chart of a method for fabricating the integrated chemical sensing system of FIG. 1.

### DETAILED DESCRIPTION

As shown in the drawings for purposes of illustration, the present patent document discloses novel techniques for a chemical sensing system capable of distinguishing the presence and/or absence of multiple chemical compounds. Previous chemical sensing systems have typically been prohibitively expensive for many applications.

In the following detailed description and in the several figures of the drawings, like elements are identified with like reference numerals.

In representative embodiments, chemical sensing systems are disclosed which can be low cost and in which an upper package housing is a substrate that provides a well-defined headspace and that protects another substrate on which are mounted various chemical sensors. The headspace volume in the upper package housing is typically obtained via an etching of the upper package housing substrate. A thermal control sub-system and a relative humidity monitoring sensor can be integrated onto a single integrated circuit die (the other substrate) with the chemical sensors. The system can also have circuitry to collect, amplify, and digitize the output signals from the chemical sensors. The thermal monitoring and control sub-system can consist of a heater assembly built into the substrate on which the chemical sensors are located. Thermal detection p-n junctions can also be built into the substrate, along with thermal sensing and control circuitry. In addition, a relative humidity sensor can be built into the substrate.

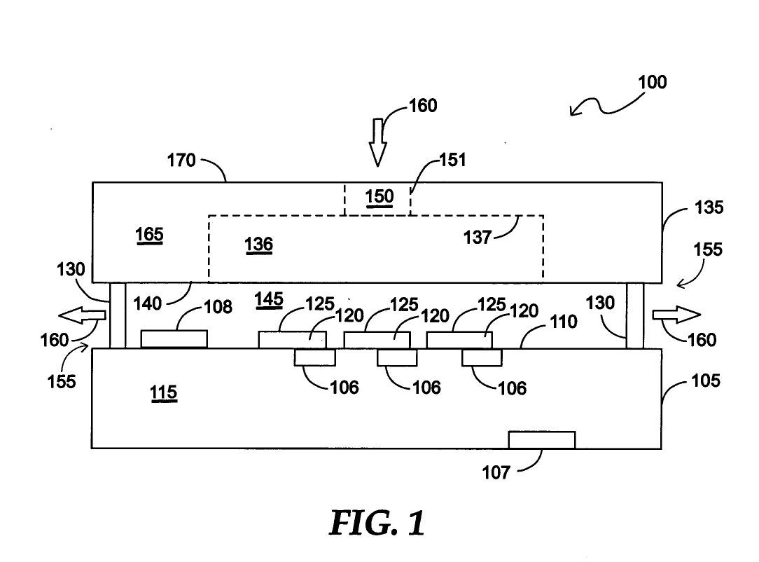

FIG. 1 is a drawing of a side view of an integrated chemical sensing system 100 as described in various representative embodiments. In FIG. 1, the integrated chemical sensing system 100, also referred to herein as the chemical sensing system 100, comprises a first structure 105 having a first surface 110, at least one spacer 130, and a second structure 135. The spacer(s) 130 provide a spatial offset between the first and second structures 105,135. The first structure 105 typically comprises a first substrate 115, the material of which in a representative embodiment can be a semiconductor and when such is the case can be referred to as first semiconductor substrate 115 and which may include other layers of other materials, as well as various integrated circuit and other structures, some of which are shown in FIG. 1. In particular, the representative embodiment of the first structure 105 shown in FIG. 1 includes heaters 106, a thermal sensor 107, which can be a p-n junction thermal sensor 107 or the like, and a humidity sensor 108. Also shown in FIG. 1, are chemical sensors 120, also referred to herein as chemical transducers 120 and as transducers 120 located on a first surface 110 of the first structure 105. The chemical sensors 120 each have a detection surface 125 whose electrical characteristics are sensitive to the presence of typically one or more compounds in the fluid state, i.e., the gaseous or liquid state. Such sensitivity is usually effected via the adsorption and/or absorption of the compound(s) to which the chemical sensor 120 is sensitive.

In its basic form, an open volume 145, also referred to herein as a volume 145 and as headspace 145, is formed by overlaying the first structure 105 with the second structure 135, wherein the second structure 135 is offset from the first structure 105 by the spacer(s) 130. The headspace 145 is bounded by the first structure 105, the second structure 135, and the spacer(s) 130. The headspace can be added to and controlled in size by precisely forming a cavity 136 in the second structure 135. A cavity surface 137 of the cavity 136 is also indicated by a dashed line in FIG. 1.

A fluid 160 enters the chemical sensing system 100 via inlet port 150, flows through the headspace 145 which includes the cavity 136 if present in the second substrate 135, and flows out of the chemical sensing system 100 through outlet port(s) 155. Inlet port 150 forms an opening into the headspace 145 via a top surface 170 of the second structure 135. The inlet port 150 is also referred to herein as first opening 150. A first opening surface 151 of the first opening 150 is also indicated by a dashed line in FIG. 1. For a given rate of flow of the fluid 160 past the chemical sensing system 100, the rate of flow of the fluid 160 into and out of the headspace 145 is controlled by appropriate design of and appropriate fabrication of at least one inlet port 150, the headspace 145, and at least one outlet port 155, also referred to herein as second opening(s) 155. Control of the rate of flow of the fluid 160 through the headspace 145 helps to increase the adsorption and/or absorption of the compound(s) to which the chemical sensor 120 reacts and thereby increases the sensitivity of the chemical sensor to the presence of the compound(s).

As shown in FIG. 1, the cavity 136 can be formed on a second surface 140 which is one of the surfaces on the second structure 135 and which is opposite the top surface 170. The second structure 135 typically comprises a second substrate 165, the material of which in a representative embodiment can be a semiconductor and as such is referred to as second semiconductor substrate 165 and which may include other layers of other materials, as well as various integrated circuit and other structures which are not shown in FIG. 1.

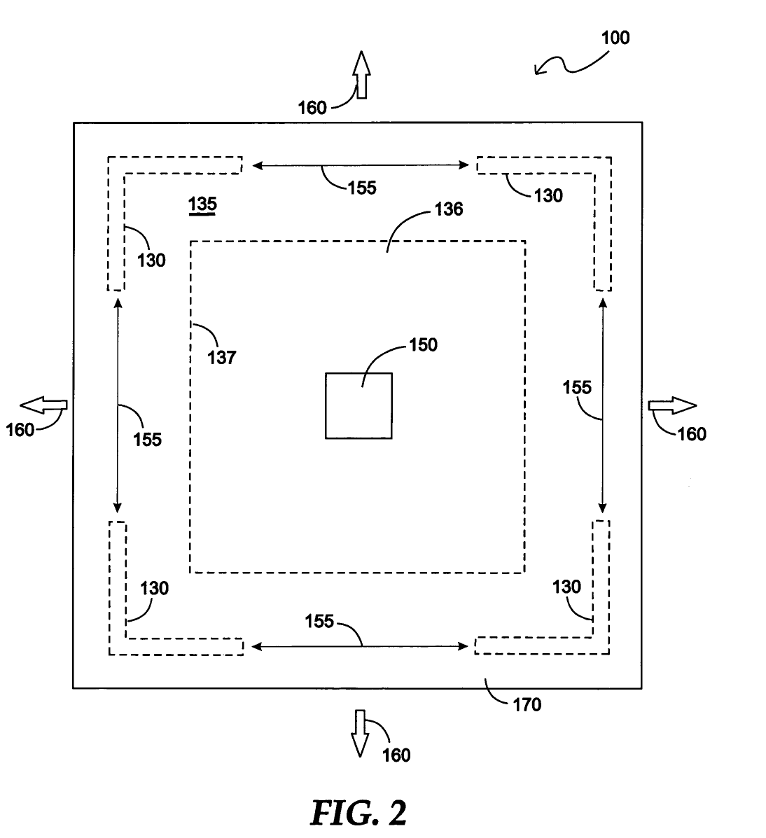

FIG. 2 is a drawing of a top view of the integrated chemical sensing system 100 of FIG. 1. FIG. 2 is shown looking down onto the top surface 170 of the second structure 135 in which the first structure 105 would be below the second structure 135. However, for illustrative purposes all characteristics of the first structure 105 are omitted from FIG. 2. For the representative embodiment of FIG. 2, four spacers 130 are shown on the opposite side of the top surface 170 (i.e., below the second structure 135) with four outlet ports 155 indicated between the four spacers 130. The cavity surface 137 of the cavity 136 is also indicated by a dashed line in FIG. 2. A top view of the inlet port 150 is shown in the center of FIG. 2. Fluid 160 is shown flowing out of the chemical sensing system 100 via the four outlet ports 155.

Various materials can be used to fabricate the components of the chemical sensing system 100. In particular, the first substrate 115 can be a semiconductor such as silicon, gallium arsenide, or the like. The second substrate 165 is typically a material capable of being readily etched which could be, for example, a single crystal material, a ceramic, quartz, a semiconductor such as silicon, gallium arsenide, or the like. The spacers can be fabricated from polyimide or other appropriate material which is preferably photo-definable. The components can be fabricated using integrated circuit materials and techniques, using hybrid circuit materials and techniques, or the like. Preferably the first substrate 115, the second substrate 165, and the spacers 130 are fabricated from materials that are not susceptible the adsorption and/or absorption of the compound(s) to which the chemical sensor 120 is sensitive.

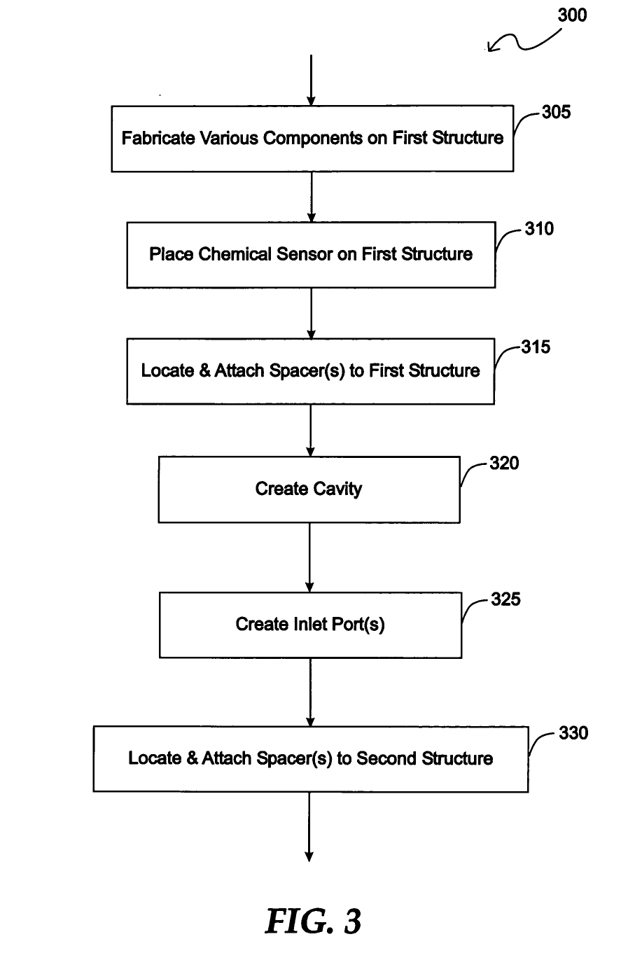

FIG. 3 is a flow chart of a method 300 for fabricating the integrated chemical sensing system 100 of FIG. 1. In block 305 of FIG. 3, various components such as the heater(s) 106, the thermal sensor 107, and the humidity sensor 108 are fabricated on the first structure 105, as well as any other integrated circuit components and interconnects useful for the intended purpose. The humidity sensor 108 can be built into the first substrate 115 using plasma-polymerized HMDSN (hexamethyldisilazine) to create a coplanar capacitor structure or by other appropriate means. Block 305 then transfers control to block 310.

In block 310, the chemical sensor(s) 120 are placed on the first surface 110 of the first structure 105. Block 310 then transfers control to block 315.

In block 315, the spacer(s) 130 are located on the first surface 110 of the first structure 105 and are attached to the first surface 110 of the first structure 105. The location and size of the spacer(s) 130 can be used to effect creation of the outlet port(s) 155. Block 315 then transfers control to block 320.

In block 320, the cavity 136 is created in the second structure 135. The cavity 136 can be created by micromachining techniques which involve photographically defining the area on the second surface 140 of the second structure 135 through which the cavity 136 is to be formed by first applying a photoresist to the second surface 140. Following appropriate exposure through a photomask having the desired geometry of the area through which the cavity 136 is to be formed and subsequent development (selective removal) of the applied photoresist, the cavity 136 is formed. Cavity 136 formation can be effected by various means depending upon the material of the second structure 135. For silicon, orientation dependent etching (OED) techniques, such as use of a heated aqueous solution of potassium hydroxide (KOH) and isopropanol, can be used to etch the defined area. The potassium hydroxide etch is orientation dependent, i.e., it etches certain crystal planes better than others. As such, <110> silicon would be the preferred silicon orientation. However, for the present purposes <100> would be acceptable as the cavity 136 is typically a few hundred microns deep with the opening area on the order of a few millimeters. Other etching techniques, as for example dry etching techniques, electrochemical etching, and the like would also be appropriate. Block 320 then transfers control to block 325.

In block 325, the inlet port 150, which may be either multiple ports or a singular port, is created. The inlet port 150 can be created by turning the second structure 135 over and etching via photolithographic steps as described above using potassium hydroxide etch, a dry etch, or other appropriate etch. The inlet port 150 can also be created by drilling through the second structure 135 into the cavity 136 or by other appropriate means. The inlet port 150 is typically smaller both in opening and in volume than is the cavity 136. However, this is not a requirement. Block 325 then transfers control to block 330.

In block 330, the second structure 135 is located over the first structure 105 and attached to the spacer(s) 130. Block 330 then terminates the process.

Flow rate control of the fluid 160 is provided by selecting the sizes of the inlet and outlet ports 150,155. In various embodiments, both inlet and outlet ports 150, 155 can be located in the first structure 105, the second structure 135, or they can be defined by openings in or between the spacer(s) 130. In other embodiments, the inlet port 150 can be located in the first structure 105 while the outlet port(s) 155 can be located in the second structure 135 or defined by openings in or between the spacer(s) 130. In still other embodiments, the inlet port 150 can be located in the second structure 135 while the outlet port(s) 155 can be located in the first structure 105 or defined by openings in or between the spacer(s) 130. And in yet other embodiments, the inlet port 150 can be defined by openings in or between the spacer(s) 130 while the outlet port(s) 155 can be located in the first structure 105 or in the second structure 135. Thus, in effect the gas inlet and the gas outlet can be reversed. Baffling can be used to help control the flow of the fluid 160.

Though indicated in FIG. 2 as being angular having generally rectangular outlines, the spacer(s) 130 can be fabricated in any appropriate shape. The spacer(s) 130 provide the ability to maintain sufficient space for flow of the fluid 160. One or more polymer-based ribs can be used as the spacer 130 assembly to provide the stand-off between the first structure 105 and the second structure 135 while permitting flow of the fluid 160 between the first and second structures 105,135. The polymer can be bare or can be coated with a material to inhibit absorption or desorption of chemical compounds that might interfere with the result of the chemical detection process. In various embodiments, the fluid 160 can be either a gas or a liquid.

A parameter describing fluid flow is conductance. Conductance is the ratio of “throughput”, under steady-state conservative conditions, to the pressure differential across a specified cross-section within a pumping system. In an analogy to the inverse of ohm's law, fluid flow is analogous to electrical current; and the pressure differential is analogous to the voltage or electrical potential drop across the system. The static pressure of the fluid 160 being analyzed can be at atmospheric pressure, above atmospheric pressure, or below atmospheric pressure.

The area of the inlet and outlet ports 150,155 may differ in size from each other. The absolute and relative sizes of the inlet and the outlet ports 150,155 can be adjusted to define where in the system the conductance limitation of the fluid 160 will occur.

Fluid 160 flow can be passive or forced. If passive, the response of the chemical sensing system 100 will be slower as diffusion will transfer these changes to the chemical sensors 120 slower than otherwise. Generally, relatively smaller inlet and outlet ports 150,155 help maintain the fluid 160 flow so that it is conductance limited. When in conductance limited mode, fluid 160 flow over the chemical sensor(s) 120 will be better maintained. In determining the flow of fluid 160 through the chemical sensing system 100, the size of the headspace 145 includes the size of the cavity 136 (if present), as well as the open volume due to the standoff of the second structure 135 from the first structure 105. The size of the cavity 136 is determined by its height (i.e., the depth of the cavity 136 into the second structure 135) and the width of the opening into the cavity 136.

As previously stated, the headspace 145 can be designed to specifications by the use of an upper die which is typically fabricated from a substrate amenable to wafer-level bonding. The geometries involved are imprecise enough such that the first structure 105 can be aligned to the second structure 135 via use of a backside alignment tool to align the two wafers together. One fluid 160 port (i.e., the inlet port 150) can be drilled into the top of the die (the second structure 135), and the other gas port(s) (i.e., the outlet port(s) 155) can be made to permit outlet flow of the fluid 160 from the periphery of the die. The second substrate 165 of which the second structure 135 comprises can be fabricated using silicon <110> for example with a combination of patterned KOH wet etching or Bosch dry etching.

Response of the chemical sensing system 100 can be damped to reduce the response of the chemical sensing system 100 to temporary fluctuations in the chemical composition of the fluid by design of the size of the inlet and outlet ports 150,155, as well as the size of the headspace 145. Appropriate design of these components can also provide a better signal to noise ratio by insuring an appropriate volume of fluid over the detection surface 125 of the chemical sensors 120, as well as rate of flow of the fluid into the volume 145, thereby insuring sufficient but not excessive adsorption/absorption of the chemical compound being detected.

Embodiments described herein have the advantage of being able to provide a precisely defined headspace, which aids in the mass calibration of such chemical sensing systems 100. The presence of the headspace which is delineated by the spacer(s) 130 and the second structure 135 also protects the chemical sensors 120 from damage during subsequent processing steps. Fabricating the chemical sensing system 100 using integrated circuit techniques and attaching the chemical sensors 120 to the individual die at the wafer level provides for a potentially low cost as the attach operation costs will be distributed across all components and all die. The chemical sensing system 100 also can include the environmental monitoring of both temperature and relative humidity intimately located near the chemical sensors so that the system can detect and with appropriate electronics quickly compensate for changes in these environmental conditions. Such electronics provide for the possibility of low cost temperature/humidity compensation. The inclusion of heaters 106 and an integrated thermal control system can also provide for thermal differential measurements to reduce issues regarding chemical sensor 120 drift. Monitoring and/or controlling these parameters can lead to more reliable measurements.

The representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed is:

1. An integrated chemical sensing system, comprising:
a first structure having a first surface, wherein the first structure comprises a first semiconductor substrate;
at least one chemical sensor having a detection surface, wherein the at least one chemical sensor is located on the first surface;
at least one spacer attached to the first surface;
a second structure having a second surface, wherein the second structure is located over the first structure, wherein the at least one spacer is further attached opposite the first surface to the second surface, and wherein a volume is created thereby between the first surface, the second surface, and the at least one spacer;
at least one inlet port; and
at least one outlet port, wherein the at least one inlet and at least one outlet ports have capability of providing entrance for a fluid into the volume and subsequent physical contact of the fluid with the detection surface.

2. The chemical sensing system as recited in claim 1, wherein size and placement of the inlet and outlet ports provide capability to control the rate of flow of the fluid over the detection surface.

3. The chemical sensing system as recited in claim 1, wherein the second structure comprises a cavity opening onto the second surface side of the second structure.

4. The chemical sensing system as recited in claim 3, wherein at least one inlet port is located in the second structure and opens into the cavity.

5. The chemical sensing system as recited in claim 3, wherein at least one outlet port is located in the second structure and opens into the cavity.

6. The chemical sensing system as recited in claim 1, wherein the second structure comprises the at least one inlet and the at least one outlet ports.

7. The chemical sensing system as recited in claim 1, wherein the second structure comprises the at least one inlet port and the at least one spacer is bounded by or penetrated by the at least one outlet port.

8. The chemical sensing system as recited in claim 1, wherein the second structure comprises the at least one outlet port and the at least one spacer is bounded by or penetrated by the at least one inlet port.

9. The chemical sensing system as recited in claim 1, wherein the at least one spacer is bounded by or penetrated by the at least one inlet port and the at least one outlet port.

10. The chemical sensing system as recited in claim 1, wherein the material of the at least one spacer is polyimide.

11. The chemical sensing system as recited in claim 1, further comprising a thermal sensor.

12. The chemical sensing system as recited in claim 1, further comprising a heater.

13. The chemical sensing system as recited in claim 1, further comprising a humidity sensor.

14. A method, comprising:
placing at least one chemical sensor having a detection surface on a first structure, wherein the first structure comprises a first surface, wherein the first structure comprises a first semiconductor substrate, and wherein the at least one chemical sensor is located on the first surface;
attaching at least one spacer to the first surface; locating a second structure having a second surface, over the first structure,
attaching the second surface to the at least one spacer opposite the first surface, wherein a volume is created thereby between the first surface, the second surface, and the at least one spacer and wherein at least one inlet and at least one outlet ports have capability of providing entrance for a fluid into the volume and subsequent physical contact of the fluid with the detection surface.

15. The method as recited in claim 14, further comprising:
creating a cavity in the second structure opening onto the second surface side of the second structure.

16. The method as recited in claim 15, wherein the step creating the cavity further comprises:
photolithographically defining the cavity opening onto the second surface; and
selectively etching the defined opening.

17. The method as recited in claim 16, further comprising:
creating the at least one inlet port, wherein the step creating the at least one inlet port comprises:
photolithographically defining the opening of the inlet port in side of the second structure opposite the second surface; and
selectively etching the defined opening of the inlet port, wherein the inlet port opens into the cavity.

18. The method as recited in claim 14, further comprising:
creating the at least one inlet port.

19. The method as recited in claim 18, wherein the step creating the at least one inlet port further comprises:
photolithographically defining the opening of the inlet port in side of the second structure opposite the second surface; and
selectively etching the defined opening.
